(19) United States
(12) Patent Application Publication
(10) Pub. No.: US 2012/0269961 A1
(43) Pub. Date: Oct. 25, 2012

(54) METHOD FOR GENERATING A CATALYST-CONTAINING ELECTRODE LAYER

(75) Inventor: Martin Batzer, Munchen (DE)

(73) Assignee: Elcomax GmbH, Munchen (DE)

(21) Appl. No.: 13/462,355

(22) Filed: May 2, 2012

Related U.S. Application Data
(63) Continuation of application No. PCT/EP2010/006696, filed on Nov. 3, 2010.

(30) Foreign Application Priority Data
Nov. 3, 2009 (DE) 10 2009 051 798.7

(51) Int. Cl. B05D 5/12

(52) U.S. Cl. 427/115

(57) ABSTRACT

A method for generating a catalyst-containing electrode layer on a substrate, particularly a catalyst layer for fuel cells or other chemical or electrochemical reactors, comprising the following steps: (A) generating an electrode layer on the substrate, wherein the electrode layer contains carrier particles for the catalyst to be deposited thereon; and simultaneously or subsequently: (B) depositing the catalyst on at least a portion of the carrier particles present in the electrode layer generated according to step (A) with decomposition of a catalyst precursor present not only superficially in the electrode layer, without external application of an electric current, an electric voltage, or an electric field, wherein no washing step takes place that could cause a discharge of the catalyst from the layer.

### CROSS-REFERENCE TO RELATED APPLICATIONS

The present application is a continuation of International Application No. PCT/EP2010/006696, filed on Nov. 3, 2010, which claims priority to German Application No. 10 2009 051 798.7, filed on Nov. 3, 2009, the contents of each of which are incorporated herein by reference.

### FIELD OF THE INVENTION

The present invention relates to a method for generating a catalyst-containing electrode layer on a substrate, especially a catalyst layer for fuel cells or other chemical or electrochemical reactors.

Such catalyst-containing electrode layers or catalyst layers represent an important component of a so-called membrane-electrode unit of all kinds of fuel cells, but are also needed, for example, in electrolyzers, reformers or very generally in other chemical or electrochemical reactors. For example, the membrane-electrode unit of a fuel cell consists of a sandwich-like structure of a first electrode layer forming the cathode, a membrane and, following this, also a second electrode layer forming the anode. On each of the two sides of the membrane-electrode unit of a fuel cell respectively there is then disposed a so-called gas-diffusion layer, through which, during operation of the fuel cell, the fuels necessary therefor (such as methanol or hydrogen) are supplied to the membrane-electrode unit and the products formed during the electrochemical fuel conversion can be removed once again. For this purpose, a catalyst promoting the fuel conversion must be present and distributed as optimally as possible in the region of the electrodes. In this respect, different requirements are applicable for the anode and cathode, and so different catalysts are used for the electrode layers in question.

### BACKGROUND

A first already known method for producing catalyst-containing electrode layers relies on the use of so-called supported catalyst particles, which are blended with further components as a paste for producing the electrode layer. These supported catalyst particles are frequently formed as carbon particles functioning as support particles, on which catalyst material was deposited at least partly, for example by means of a chemical deposition process. For this purpose, a solution of the support particles and a catalyst precursor is first prepared. Then the catalyst precursor is decomposed in suitable manner, whereby the liberated catalyst material is finally deposited on the support particles. However, the use of a supported catalyst synthesized in such a way in a paste used for generation of an electrode layer suffers from disadvantages. In particular, the deposited catalyst in an electrode layer produced from a corresponding paste is found not only at those sites within the electrode layer at which the presence of a catalyst is actually necessary, which ultimately is associated with very high and inefficient—and therefore uneconomical—loading of the electrode layer with partly unusable catalyst material. This disadvantage is particularly pronounced in electrode layers having relatively large area.

Since the use of a supported catalyst is advantageous in principle, however, for example by virtue of the possibility of providing a very highly active area for the catalyst, other approaches toward generation of catalyst-containing electrode layers or catalyst layers were taken as part of the further progress, and some of those are still considered state of the art even today.

These include the method of electrochemical deposition described in diverse variants, for example in U.S. Pat. No. 5,084,144, DE 19720688 C1, EP 1307939 B1 or EP 1391001 B1. According to the method from the two last-cited European Patents, firstly a precursor layer containing the catalyst material in the form of a catalyst precursor (for example, a salt containing the catalyst) is provided on a membrane and then the catalyst is deposited therein by electrochemical means, or in other words by externally supplying an electrical current, an electrical voltage or an electrical field. Hereby the needed amount of the chosen catalyst—which is usually very expensive—can be significantly reduced, since the electrochemical deposition operation advantageously takes place only in the region of the so-called three-phase boundary, at which electronic and ionic conductivity is also present in addition to contact with the process media being supplied to the fuel cell—as is optimum for efficiency of fuel conversion during operation of a fuel cell or of another chemical or electrochemical reactor. A disadvantage in this respect, however, is the high equipment complexity, in which electrical contacting of the layers to be produced must be achieved in particular in a suitable sample chamber. Furthermore, the membrane must be kept moist by appropriate means during the electrochemical deposition process (for example, by means of water or steam), in order to maintain the level of electrical conductivity necessary for the deposition operation.

An improvement of this method, likewise already known, is described in WO 2008/104322 A2. In this method, firstly a structured electrode layer is generated and then the catalyst is deposited—again electrochemically—on carbon particles present in the structured layer and functioning as support for the catalyst. In this case, also, however, suitable conductivity of the membrane is to be ensured during the electrochemical deposition operation, and the provision of an external electrical voltage, an external electrical current or an electrical field generated by suitable means is an imperative prerequisite for achieving the described method.

Further already known methods for manufacturing catalyst-containing electrode layers are known from the scientific literature. For example, Qiao et al., in the article entitled “Evaluation of a passive microtubular direct methanol fuel cell with PtRu anode catalyst layers made by wet-chemical processes” (Journal of the Electrochemical Society, 2006, Vol. 153, pp. A42-A47), describe a method for producing an anode catalyst layer by impregnating the membrane and then chemically reducing a catalyst precursor impregnated into the membrane. In this case, however, ultimately unsupported catalysts are produced on and inside the membrane, which proves to be disadvantageous as regards the ratio of active surface to catalyst need and as regards the accessibility of the deposited catalyst for the process media.

A further already known method for catalyst synthesis is described by the phrase “Impregnation method” or “Method of impregnation”, in which a catalyst support, usually suitable industrial carbon black, is mixed with an aqueous solution containing a catalyst precursor, so that the surface of the catalyst support can be covered with the catalyst precursor. Thereafter the depleted solution is either filtered or evaporated off, and then the supported catalyst is generated by chemical reduction. In this case also, therefore, only a supported catalyst is generated, which—as already mentioned in the introduction—is to be blended to a suitable electrode paste. This also results in an uneconomical distribution of the catalyst within the entire electrode layer.

Further, DE 102007033753 A1 discloses a method in which a catalyst coating on a gas-diffusion electrode is formed by applying an aqueous precursor solution on a conductive, ultrahydrophobic substrate and then depositing the catalyst chemically or preferably electrochemically. In this case obviously only a superficial deposit of the catalyst is obtained. Thus the consumption of platinum is indeed relatively low, but on the whole only a slight catalytic activity or performance can be achieved in a membrane-electrode unit with a gas-diffusion electrode produced in such a way.

And finally DE 10047935 A1 discloses an electrode for a fuel cell comprising a composite electrode of polymer solid electrolyte and catalyst, which contains a cation-exchange resin, carbon particles and catalyst metal, wherein the catalyst metal is loaded mainly at a location at which a surface of the carbon particles comes in contact with a proton-conducting channel in the resin. For this purpose the electrode layer generated initially must be soaked for an extremely long period of 2 days in a solution containing the catalyst (such as platinum), in order that the ion-exchange process, which takes place on a long time scale but is necessary for selective deposition of the catalyst, can be completed. As a result, on the one hand catalyst or metal particles are indeed deposited in the desired sense at the ends of ion-exchange channels. On the other hand, however, adhesion of catalyst or catalyst compounds also occurs in the interior of the proton-conducting channels of the cation-exchange resin (or in other words at sites at which the catalyst is inactive and/or at sites that block or hinder media contact with catalyst particles present in the same proton-conducting channel during subsequent operation of a fuel cell), with the consequence that the electrode must be washed in a thorough washing step, for example with deionized water, after the protracted soaking in the precursor solution, whereby a not inconsiderable part of the catalyst is entrained from the layer once again.

### SUMMARY

Against this background, it is the object of the present invention to provide a new method for generating a catalyst-containing electrode layer on a substrate, especially a catalyst layer for fuel cells or other chemical or electrochemical reactors, which method can be performed inexpensively and rapidly with simultaneously good catalyst utilization and which exhibits further advantages explained in more detail hereinafter.

This invention is achieved with a method according to claim 1, comprising the following steps:
(A) generating an electrode layer on the substrate, wherein the electrode layer contains support particles for the catalyst to be deposited thereon
and simultaneously or subsequently:
(B) depositing the catalyst on at least one part of the support particles present in the electrode layer with decomposition of a catalyst precursor present in the electrode layer and not merely at the surface without external application of an electrical current, an electrical voltage or an electrical field,
   wherein no washing step that could cause entrainment of catalyst from the layer is performed.

Within the scope of the present invention, it was surprisingly discovered that efficient and simultaneously inexpensive deposition of the catalyst on the support particles present in an electrode layer is possible with correspondingly low catalyst input, even without performance of an electrochemical deposition operation and without the associated equipment complexity. The catalyst layers generated with the inventive method exhibit characteristics at least comparable to those achievable from generation of corresponding layers by means of the much more complex electrochemical deposition, especially as regards the specified catalyst utilization, the distribution of the catalyst in the generated catalyst layer on the support particles as well as the achievable catalytic activity in subsequent operation of a fuel cell (or of another chemical or electrochemical reactor).

A first important aspect for this purpose is that the deposition of the catalyst takes place substantially only at those sites within the electrode layer generated previously or simultaneously that are accessible for the process media in the subsequent operation of a fuel cell (or of another chemical or electrochemical reactor). The deposition of the catalyst in the electrode layer and not merely at the surface ensures that deeper layers of the electrode are also catalytically active, wherewith much better performing membrane-electrode units can be achieved compared with the prior art known from DE 102007033753 A1.

By the integration, achieved within the scope of the present invention, of an operation—which does not take place electrochemically—of deposition of the catalyst (for example, by chemical and/or thermal reduction of a catalyst precursor) into the process of manufacture of the end product (for example, the production of a membrane-electrode unit for a fuel cell), however, still further advantages are achieved. In particular, a smaller safety risk exists over the entire production operation, since the reactive catalyst is introduced only during a very late step of the method, namely with or after generation of the electrode layer. Further, in the inventive method, (almost) complete conversion of the catalyst can take place, and any washing steps that may be disadvantageously needed in the prior art, wherein disadvantageous entrainment of catalyst from the layer may be expected, are completely unnecessary.

Finally, it must be mentioned for clarification that the chosen concept of decomposition of the catalyst precursor comprises in particular chemically or thermally induced reduction of the catalyst precursor but is not limited thereto. In particular, for example in connection with platinum deposition, as is frequently provided on the electrode layer forming the cathode for a fuel cell, it is intended that the possible use of a Pt(0) precursor and the decomposition process that takes place in this respect, also be embodied therein.

A first advantageous embodiment variant of the inventive method provides that the electrode layer is produced from an electrode layer paste, which contains the support particles and in which the catalyst precursor is already blended. This variant of the invention proves particularly advantageous, especially from the process engineering viewpoint, since here the deposition—which does not take place electrochemically—of the catalyst can be performed simultaneously with the generation of the electrode layer according to step (A), for example during a step—which may take place during generation of the electrode layer—of drying and/or heat treatment of the electrode layer produced from the electrode layer paste, thus assuring faster progress of the method. During such a drying and/or heat-treatment step, the method steps explained in more detail hereinafter, of exposure of the electrode layer to a liquid and/or gaseous reducing agent and/or to an elevated temperature, may then take place, for example even simultaneously. In this case, preferably care will be taken that a period of not longer than approximately 20 minutes elapses between the blending of the catalyst precursor with the electrode layer paste and the beginning of the ensuing deposition operation.

In contrast, it may be provided in a second—alternative—embodiment variant of the inventive method that the electrode layer is impregnated with a solution containing the catalyst precursor only after its generation according to step (A), which in turn is accompanied by other advantages.

In this regard it must be mentioned firstly that the solution containing the catalyst precursor—due to the impregnation that takes place only after generation of the electrode layer—can migrate exclusively into those regions of the electrode layer already generated in a previous step into which the process media of a fuel cell (or of another chemical or electrochemical reactor) are able to migrate subsequently, wherewith the catalyst is deposited only at sites that are practical in this respect, thus increasing its usable yield. Further, because of the impregnation of the electrode that takes place only later with the solution containing the catalyst precursor, a higher degree of flexibility is achieved as regards the composition of a paste forming the electrode layer, in which paste substances (such as solvents) harmful for the catalyst may even be used if necessary, in any case provided they volatilize before completion of generation of the electrode layer, wherewith in this respect they no longer represent any risk, after generation of the layer, for the catalyst that only then is to be deposited in the layer. Likewise in the case of impregnation taking place only later, the electrode layer may be treated beforehand, for example by exposure to high temperature, in a way that would be detrimental or even not at all possible in the presence of the catalyst or of a catalyst precursor. The handling and the storage of electrode layers produced ahead of time is also greatly facilitated in the absence of a catalyst or catalyst precursor.

The inventive dispensation with a washing step that could cause entrainment of the catalyst (or of the catalyst precursor) from the layer may be adopted especially in the present case, since the impregnation of the electrode layer with a solution containing the catalyst precursor can preferably be performed—in comparison with the prior art—in very short time scales in the present case. The actual impregnation of the electrode layer with the solution containing the catalyst precursor, for example by dropwise application or spraying of the solution, should then be performed advantageously only over a period between 1 second and 10 minutes, even more advantageously over a period between 0.5 and 5 minutes.

The subsequent deposition of the catalyst in the inventive sense (method step B) may then preferably begin immediately after impregnation of the electrode layer with the solution containing the catalyst precursor, wherein advantageously not more than 20 minutes, even more preferably only 0-5 minutes, should elapse between the end of impregnation and the beginning of deposition, and wherein no washing step is performed in the interim.

Since the impregnation step therefore takes place advantageously only over a relatively short period, undesired deposition of the catalyst precursor in ion-conducting channels of a cation-exchange resin (such as a Nafion solution) present in an electrode layer can be largely avoided, since the ion-exchange processes necessary therefor proceed on much longer time scales. Thus extensive deposition of the catalyst in such channels, as is provided, for example, according to DE 10047935 A1, does not take place at all in the present case.

In principle, complete penetration of the electrode layer by the catalyst precursor can be achieved in the scope of the present invention with only subsequent impregnation of the electrode layer with the catalyst precursor—even given the short impregnation times mentioned in the foregoing—which indeed may be advantageous—especially for relatively thin electrode layers with layer thicknesses of several 10 μm—but not absolutely necessary. Advantageously the impregnation will be controlled such that the catalyst precursor migrates to a penetration depth of at least 2 μm-100 μm, advantageously of 10 -50 μm into the electrode layer, since even such deep layers of the electrode are catalytically active. Within the scope of the present invention, a sufficient penetration depth can be achieved regardless of whether the electrode layer is hydrophilic or hydrophobic due to corresponding choice and/or treatment of its components. Provided an appropriate solvent is chosen, even an ultrahydrophobic electrode layer may be used for the solution containing the catalyst precursor.

And finally the introduction or impregnation of the catalyst precursor into the electrode layer can be controlled selectively, for example—in yet another preferred improvement of the method variant mentioned in the foregoing—by selectively impregnating the electrode layer inhomogeneously with the solution containing the catalyst precursor. This inhomogeneity relates on the one hand to selective control of the amount of solution containing the catalyst precursor applied per unit area of the electrode layer, whereby a specifically adjustable platinum concentration gradient can be generated over the surface and if necessary also the penetration depth of the electrodes oriented perpendicular thereto, if necessary with additional application of suitable drying steps, which may favor inhomogeneous distribution of the catalyst.

In both variants of the inventive method mentioned in the foregoing, yet another preferred improvement of the invention provides that the deposition of the catalyst according to step (B) is induced thermally and/or by a reducing agent in liquid or gaseous form in contact with the electrode layer.

Although deposition of the catalyst can in principle be induced purely thermally or purely chemically in the scope of the present invention, especially a combination of these two method steps, which may be performed either simultaneously or successively, is a particularly effective kind of chemical deposition, since it is supported by two different mechanisms of action.

Any chemical compound or composition by means of which the catalyst in question can be deposited by chemical reduction from the catalyst precursor specifically being used can be regarded as a reducing agent for this purpose. Examples of suitable liquid reducing agents are solutions that contain KBH₄, NaBH₄, LiAlH₄ and/or N₂H₄. Examples of gaseous reducing agents suitable for use are hydrogen, SO₂, CO, CH₄ and/or NH₃.

As regards the catalysts, it must be mentioned that the present invention favors in particular the noble metal catalysts normally used in fuel cells or other chemical or electrochemical reactors, such as platinum, ruthenium, rhodium, gold, silver, copper or alloys thereof (for example, platinum alloys such as PtRu), wherewith suitable noble metal salts are preferred for the catalyst precursors in question. Possible examples thereof will be listed in more detail hereinafter. In this respect, however, it is already worth mentioning at this place that a mixture—existing in an appropriate mixing ratio—of catalyst precursors for the different alloy components can be used in particular for deposition of a noble metal alloy functioning as the catalyst.

The use of liquid or gaseous reducing agents on an already generated electrode layer contributes—regardless of whether the catalyst precursor was already present in the electrode layer paste or was applied only later in dissolved form onto the electrode layer—to ensuring that the catalyst deposition caused with the inventive method takes place exclusively in those relevant regions of the electrode layer that subsequently will also be accessible for the process media of the fuel cell (or of another chemical or electrochemical reactor). After all, the chemically induced deposition takes place only in regions that are accessible for the reducing agent—and thus also subsequently for the process media.

Particularly preferably, a gaseous reducing agent such as hydrogen will be used, since this is able advantageously to penetrate into the smallest interstices/pores of the electrode layer, whereby widely branched deposition of the catalyst takes place even on the smallest support particles present in the electrode layer, thus improving the catalytically active surface of the generated catalyst layer even more. Here it must be kept in mind that, especially in the case of impregnation performed only after generation of the electrode layer, it is already assured that the catalyst precursor will be present only where the solution containing the catalyst precursor can also penetrate, thus representing an important criterion for the efficiency of the correspondingly chemically induced deposition operation as regards the best possible yield of catalytically active regions in the catalyst layer produced according to the invention.

In the case of use of a gaseous reducing agent (such as gaseous hydrogen), this may be applied most simply, by exposing the electrode layer—in a sample chamber suitable for the purpose—to an atmosphere containing the gaseous reducing agent, thus representing a means, achievable in particularly simple and inexpensive manner, of exposing the electrode layer to an effective reducing agent. Such an atmosphere contains—unless it is composed 100% of the gaseous reducing agent—not only the gaseous reducing agent but also, as a further component, preferably exclusively an inert gas, for example nitrogen, or a noble gas. The proportion of the reducing agent in such an atmosphere is preferably at least 20 wt % or at least 30 wt %.

Further, in yet another preferred improvement of the inventive method, it is provided that the electrode layer is exposed in step (B) to a temperature from room temperature (=20° C.) to 400° C. or higher, particularly preferably to a temperature of 50° C. to 250° C., and even more preferably of 100° C. to 150° C., as is possible by means of an appropriately heatable sample chamber. These temperature ranges prove to be expedient both as regards the efficiency in terms of the desired reduction of the catalyst precursor and also as regards their harmlessness for the materials usually present in electrode layers produced according to the invention. The maximum temperature possible in this regard—without damage to the electrode layer—is determined by the thermal stability of the electrode layer or of the components present in it. In the case of Nafion-containing electrode layers, temperatures higher than 150° C., for example, should be avoided, in order to prevent decomposition of the Nafion, whereas temperatures of well over 400° C. are possible without damage to the electrode layer in Teflon-containing electrode layers for HT PEM fuel cells.

It has been found that, in the scope of an inventive method with simultaneous exposure of the electrode layer to temperature and reducing agents, sufficient and efficient catalyst coverage of the support particles present in the electrode layer can already be achieved in unexpectedly short time spans. In step (B), therefore, the electrode layer may advantageously be exposed simultaneously, for only a period of approximately 1 to 30 minutes, especially for a period of approximately 5 to 15 minutes, to an atmosphere that contains a gaseous reducing agent and to a temperature in the range of 100° C. to 150° C., which is of great advantage in particular for industrial and inexpensive manufacture of corresponding catalyst layers.

The electrode layer generated in step (A) of the inventive method is preferably generated from an electrode layer paste, in which the support particles are mixed with solvent and/or at least one further component.

Carbon particles, especially in the form of (industrial) carbon black, which may be pulverulent or pulverized, are suitable in particular as support particles. In this respect, however, support particles of other materials, for example of graphite, graphitized carbon black, TiO₂, tungsten carbide or titanium carbide, are likewise suitable. Further, these may also exist in the form, for example, of carbon nanotubes, TiO₂ nanotubes, carbonized TiO₂ nanotubes, etc.

It is further particularly advantageous when the electrode layer paste contains an electrolyte material as a further component, for example in the form of Nafion®, a Nafion solution or PBI doped with phosphoric acid, etc., whereby some proton conductivity (ionic conductivity) is imparted to the electrode layer. Surface-altering substances, such as Teflon, for example, or chemical binders may also be blended advantageously into a suitable electrode layer paste.

Furthermore, it may be advantageously provided that the electrode layer is generated as a structured layer, by composing the support particles inhomogeneously in terms of at least one particle characteristic, such as material, shape, size or surface structure, or by structuring the electrode layer by the use of templates or by other structure-imparting methods, such as nanoimprint methods or the like.

In a method according to the present invention, deposition of a Pt, Ru or PtRu catalyst can be achieved particularly advantageously by the use, as the catalyst precursor, of H₂PtCl₆, Pt(NO₂)₃, (NH₄)₂PtCl₆, Na₂PtCl₆, K₂PtCl₆, H₂Pt (OH)₆, PtO₂, PtCl₄, H₂Pt (SO₄)₂, [Pt (NH₃)₃NO₂]NO₂, RuCl₃, (NH₄)₃RuCl₆ or H₃RuCl₆, or bimetallic precursors such as PtRu₅C(CO)₁₆ or Pt₂Ru₄(CO)_{18,} or mixtures of the said catalyst precursors. To deposit a gold catalyst, it is possible to use HAuCl₄, (NH₄)₃Au(SO₃)₂ and/or K₃Au(SO₃)₂, for example, as catalyst precursors. For rhodium deposition, Rh₂(SO₄)₃, RhCl₃ and/or Na₃RhCl₆ may be used as precursors. Ag₂SO₄ or KAg(CN)₂ can be used for silver deposition and CuSO₄ for copper deposition. Obviously this list is not conclusive, since further catalyst precursors may also be used to perform the inventive method, especially for other noble metals or metals (such as cobalt, nickel, tungsten, selenium, etc.) and/or (noble) metal alloys that may be desired, especially in the form of salts of the (noble) metals in question, without departing from the technical teaching according to the invention.

Advantageously a gas-diffusion layer for a fuel cell, a polymer electrolyte membrane or another substrate in the form of a film or fabric may be used in particular as the substrate functioning as base for the electrode layer to be generated. In particular, by application of the inventive method, it is first possible with method step (A) to produce an electrode layer that is free of catalyst precursor, is easy to handle and can also be stored for a relatively long period without quality losses. In this case, the inventive method step (B) may be performed even a considerable time after method step (A), for which purpose, however, the generated electrode layer must still be impregnated with a solution containing a catalyst precursor. This impregnation may be performed in the most diverse ways, for example by dropwise application or spraying of the solution.

Hereinafter an illustrative exemplary embodiment of an inventive method will be explained on the basis of generation of a catalyst layer for the cathode side of a direct methanol fuel cell, in which pure platinum is used as the catalyst.

In this respect a gas diffusion layer (GDL) of conventional type is used as the substrate. Thereon there is applied a paste mixed together from finely powdered industrial carbon black and Nafion® (for example, consisting of 50 wt % [per cent by weight] carbon black and 50 wt % Nafion) by means of a doctor blade in a layer thickness customary for electrode layers (such as 5-100 μm). The particles of carbon black present in the electrode layer paste or in the electrode layer generated therefrom thus function as support particles for the platinum to be deposited thereon in a subsequent step of the method.

The electrode layer, which either may be still moist or already dry, is then impregnated by controlled dropwise application of the needed amount of an alcoholic—and therefore wetting—solution (for example, on an isopropanol basis) containing H₂PtCl₆ as platinum precursor in a desired concentration. For this purpose the solution contains, for example, 15 wt % of pure platinum, or in other words a precursor content corresponding to the said proportion of pure platinum. Immediately after impregnation of the electrode layer with the catalyst-containing precursor solution, the still-moist electrode layer is heated to 110° C. in a suitable sample chamber for duration of 10 minutes in a hydrogen-containing atmosphere. The atmosphere advantageously consists of 30-100% hydrogen and an inert gas, such as nitrogen. In the process, the platinum precursor is converted to finely distributed metallic platinum, which is now deposited on the industrial carbon black of the electrode layer, or in other words is then fixed there.

The gas diffusion layer obtained in such a way, with a catalyst-containing electrode layer disposed thereon, may now be further processed, for example by generating it in conventional manner together with a second GDL, on which the anode-side electrode layer containing, for example, PtRu as catalyst is generated, and pressing a polymer electrolyte membrane—to be disposed between the two catalyst layers—in order to form a membrane-electrode unit.

We claim:

1. A method for generating a catalyst-containing electrode layer on a substrate, especially a catalyst layer for fuel cells or other chemical or electrochemical reactors, comprising the following steps:
(A) generating an electrode layer on the substrate, wherein the electrode layer contains support particles for the catalyst to be deposited thereon
and simultaneously or subsequently:
(B) depositing the catalyst on at least one part of the support particles present in the electrode layer generated according to step (A) with decomposition of a catalyst precursor present in the electrode layer and not merely at the surface without external application of an electrical current, an electrical voltage or an electrical field,
wherein no washing step that could cause entrainment of catalyst from the layer is performed.

2. A method according to claim 1, wherein the electrode layer is produced from an electrode layer paste, which contains the support particles and in which the catalyst precursor is already blended.

3. A method according to claim 1, wherein the electrode layer is impregnated with a solution containing the catalyst precursor only after its generation according to step (A).

4. A method according to claim 3, wherein the electrode layer is selectively impregnated inhomogeneously with the solution containing the catalyst precursor.

5. A method according to claim 1, wherein the deposition of the catalyst according to step (B) is induced thermally and/or by a reducing agent in liquid or gaseous form in contact with the electrode layer.

6. A method according to claim 5, wherein the electrode layer is exposed in step (B) to an atmosphere containing the gaseous reducing agent.

7. A method according to claim 5, wherein the electrode layer is exposed in step (B) to a temperature from room temperature to 400° C. or higher, especially between 50° C. and 250° C., particularly preferably to a temperature of 100° C. to 150° C.

8. A method according to claim 7, wherein the electrode layer is simultaneously exposed in step (B), for a period of approximately 1 to 30 minutes, especially for a period of approximately 5 to 15 minutes, to an atmosphere that contains a gaseous reducing agent and to a temperature in the range of 100° C. to 150° C.

9. A method according to claim 5, wherein the electrode layer is generated from an electrode layer paste, in which the support particles are mixed with solvent and/or at least one further component.

10. A method according to claim 5, wherein the electrode layer is generated as a structured layer, by composing the support particles inhomogeneously in terms of at least one particle characteristic, such as material, shape, size or surface structure, or by structuring the electrode layer by the use of templates or by other structure-imparting methods.

11. A method according claim 5, wherein the catalyst is a noble metal or a noble metal alloy, especially platinum or a platinum alloy.

12. A method according to claim 11, wherein H₂PtCl₆, Pt(NO₂)₃, (NH₄)₂PtCl₆, Na₂PtCl₆, K₂PtCl₆, H₂Pt(OH)₆, PtO₂, PtCl₄, H₂Pt(SO₄)₂, [Pt(NH₃)₃NO₂]NO₂, RuCl₃, (NH₄)₃RuCl₆, H₃RuCl₆, HAuCl₄, (NH₄)₃Au(SO₃)₂, K₃Au(SO₃)₂, Rh₂(SO₄)₃, RhCl₃, Na₃RhCl₆, Ag₂SO₄, KAg(CN)₂ or CuSO₄ or bimetallic precursors such as PtRu₅C(CO)₁₆ or Pt₂Ru₄(CO)_{18,} or mixtures of the said catalyst precursors are used as the catalyst precursor.

13. A method according to claim 5, wherein a gas-diffusion layer for a fuel cell, a polymer electrolyte membrane or another substrate in the form of a film or fabric is used as the substrate.
